(19) United States
(12) Patent Application Publication
(10) Pub. No.: US 2004/0245483 A1
(43) Pub. Date: Dec. 9, 2004

(54) Radiation application method and device

(76) Inventors: Berend Jakobus Smit, Stellenbosch (ZA); Willem Adolf Groenewald, Stellenbosch (ZA); Juanus Paul Apffelstaedt, Stellenbosch (ZA)

Correspondence Address: BURNS DOANE SWECKER & MATHIS L L P, POST OFFICE BOX 1404, ALEXANDRIA, VA, 22313-1404, US

(21) Appl. No.: 10/479,410

(22) PCT Filed: May 15, 2002
(86) PCT No.: PCT/IB02/01655

(30) Foreign Application Priority Data
May 15, 2001 (ZA) 2001/3903

(51) Int. Cl. G21F 5/00

(52) U.S. Cl. 250/506.1

(57) ABSTRACT

The invention provides a method and device for applying radiation to a wound cavity resulting from a lumpectomy. The device comprises a non-deformable body of PTFE or similar material, with a rounded head and elongate stem or handle. The stem defines a channel which extends to the centre of the head for receiving a radiation source from a High Dose Rate, Remotely Controlled After-loading Brachytherapy Unit (HDRRCABU). The head of the device is inserted into the wound cavity and the wound is closed, so that the tissue forming the wound cavity is given a precisely controlled dose of radiation in a matter of minutes/hours rather than days/weeks.

### BACKGROUND OF THE INVENTION

THIS invention relates to a method and device for the application of radiation which can be used, in particular, in the treatment of cancer such as breast cancer.

One method of treating cancer, and breast cancer in particular, is radiotherapy. Conventional radiotherapy treatment of the breast may lead to undesirable damage to large areas of tissue, and therefore the total dosage of radiation that can be delivered to the malignant tissue is limited. A number of radiation techniques are used, including conventional radiotherapy and intra-operative electron therapy. In the latter case, the tumour bed to be irradiated must be exposed and manipulated to accommodate the electron applicator, which is tedious or imprecise. Brachytherapy is a form of intra-operative radiation therapy in which a radiation source is placed in or near the malignant tissue, typically utilising catheters into which are inserted radioactive wires near to the tumour to be irradiated. For example, U.S. Pat. No. 6,179,766 describes a brachytherapy method for treating breast cancer.

It remains an ongoing problem to be able to control the intensity, distribution and depth of radiation applied to the tissue to be irradiated, while protecting healthy tissue and minimising the dose of radiation applied to it. It is also desirable to minimise the time required for a course of radiotherapy, and the extent of sedation or anaesthetia required to administer the treatment.

### SUMMARY OF THE INVENTION

According to the invention there is provided a radiation application device comprising a body having a head portion shaped to be positioned within a wound cavity resulting from removal of a tumour, and a relatively narrow stem portion sized to protrude out of the wound cavity, the body defining a channel therein for receiving and locating a radiation source in a predetermined position so that tissue of the wound cavity adjacent the head of the device receives a predetermined dose of radiation from the radiation source.

Preferably, the head portion defines a rigid outer surface which can be brought into firm engagement with the tissue of the wound cavity, thereby to locate the radiation source accurately relative to the tissue.

The body may be solid and preferably comprises a material which is substantially transparent to ionising radiation.

For example, the body may comprise PTFE or another suitable plastics material.

The head portion may be spherical or spheroidal, with a diameter in the range 40 to 70 millimeters.

The channel in the body may be tubular and be sized to receive a guide tube for the radiation source.

Preferably, the channel extends through and terminates a distance beyond the centre of the head portion calculated to position the radiation source at the centre of the head portion in use.

The stem portion may have a coupling provided at an end thereof remote from the head portion which is adapted to receive the guide tube and to clamp it in position relative to the device.

The coupling is preferably compatible with a guide tube of a conventional High Dose Rate, Remotely Controlled After-loading Brachytherapy Unit (HDRRCABU).

Further according to the invention there is provided a method of administering radiation to human tissue comprising:

providing an applicator body defining a rigid wound-engaging surface;

inserting the applicator body into a wound cavity so that the wound-engaging surface thereof is in contact with the tissue defining the cavity;

locating a radiation source in the applicator body;

leaving the applicator body in position in the cavity for a period of time calculated to deliver a desired dose of radiation to the tissue adjacent the cavity; and

removing the applicator body from the wound cavity.

The applicator body may be inserted via a wound opening which is closed about the body so that the tissue defining the wound cavity contacts the tissue-engaging surface of the body firmly.

The radiation source may be introduced into the applicator body via a guide tube after insertion of the applicator body into the wound cavity.

The radiation source is preferably an isotropic point source and may comprise Iridium 192 or Caesium 37, for example. The radiation dose delivered at the surface of the applicator is preferably between 5 Gy and 30 Gy.

In an example of the method the radiation dose delivered at the surface of the applicator was about 21 Gy.

referably, the radiation dose is effectively administered to a layer of tissue surrounding the applicator body with a thickness between 0 and 20 millimeters.

In the cited example of the method, the radiation dose is effectively administered to a layer of tissue surrounding the applicator body with a thickness of about 10 millimeters.

The radiation dose is preferably administered as a single dose, but could be delivered in several fractions or dose increments if desired.

### BRIEF DESCRIPTION OF THE DRAWINGS

FIG. 1 is a schematic side view of a human breast showing a carcinoma therein;

FIG. 2 is a schematic side view corresponding to FIG. 1, showing a wound cavity remaining in the breast after surgical removal of the carcinoma;

FIG. 3 is a similar view to that of FIGS. 1 and 2, showing a radiation application device of the present invention inserted into the wound cavity;

FIG. 4 is a front view corresponding to FIG. 3, showing the radiation application device in position;

FIG. 5 is a side view of the radiation treatment device of the present invention;

FIG. 6 is a diagrammatic illustration of the use of the radiation application device with a High Dose Rate, Remotely Controlled After-loading Brachytherapy Unit (HDRRCABU); and

FIG. 7 is a schematic side view corresponding to FIGS. 1 to 3, illustrating the radiation isodosage distribution of the device in use.

### DESCRIPTION OF EMBODIMENTS

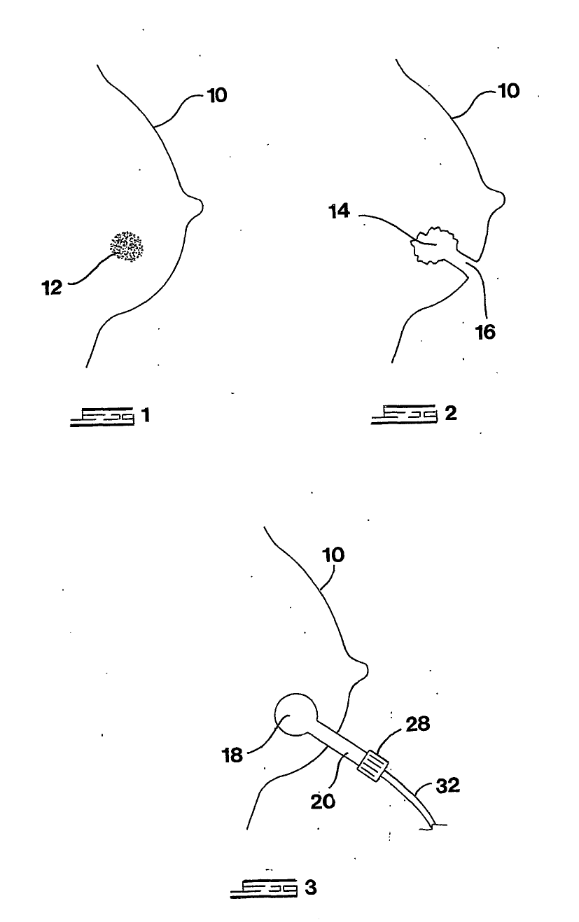

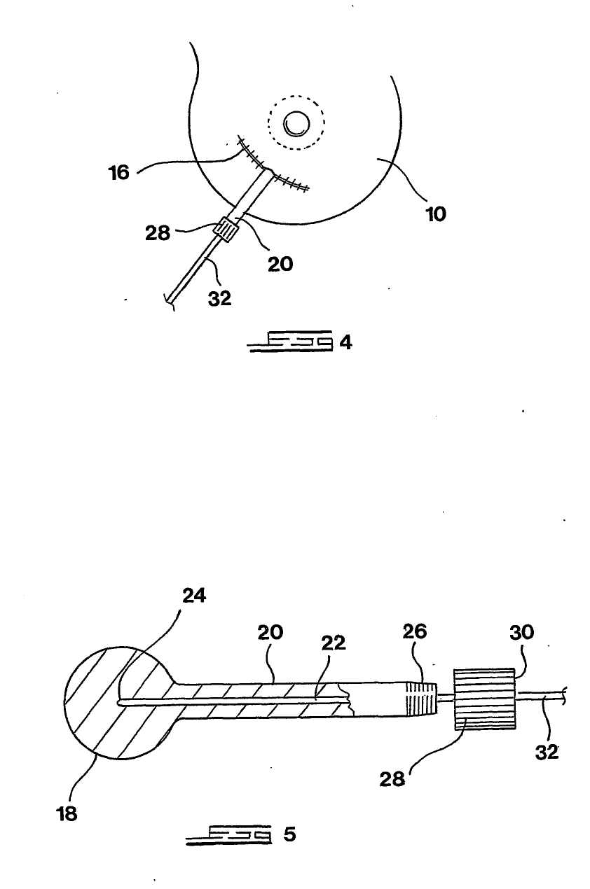

FIG. 1 is a schematic side view of a human female breast 10 in which breast cancer has manifested in the form of a carcinoma 12. FIG. 2 is a similar view to that of FIG. 1, showing a wound cavity 14 which remains in the breast after removal of the carcinoma by way of a so called “lumpectomy”. Conventionally, the wound opening 16 would be closed by stitching and a course of radiotherapy would then be administered to the general area of the wound or tumour bed.

Conventionally, a “radical” dose of 50 Gy of radiation is delivered to the breast over a period of about one month, and a further five days are required to deliver a so-called booster dose of 10 Gy. In such conventional radiation treatment, the entire volume of the breast is irradiated, and in some cases part of the axilla or parts of the opposite breast are also irradiated. Because of the curvature of the chest wall, it is very difficult to exclude the radio-sensitive tissues of the underlying lung.

The reason for irradiating such large volumes of tissue is that it is difficult to locate the tumour bed accurately after closing and healing of the surgical wound, and generous margins are necessary to ensure proper coverage of the tumour bed. In addition, it is difficult technically to irradiate a very limited part of the breast due to the constraints of beam delivery.

An alternative technique which has been used is to implant the tumour bed with radioactive iridium wires in theatre, but this has the serious drawback of increasing theatre time markedly, and exposing the theatre staff to radiation. After placement of the wires, orthogonal x-rays have to be taken in order to determine the wire positions for dosimetric purposes and the patient subsequently has to remain in a special concrete ward in isolation for several days.

The radiation application method and device of the present invention provide an alternative form of postoperative radiation treatment.

The radiation application device is shown in FIG. 5, and comprises a bulbous head portion 18 which is preferably spherical or spheroidal, and an elongate stem portion 20 which serves both as a handle for manipulating the device and as a connector for a guide tube which guides a radioactive source into the head of the device. The stem 20 extends radially away from the spherical head 18, and defines a tubular bore or channel 22 which extends into the head 18. The end 24 of the channel is located just beyond the center of the head 18, so that a radioactive point source introduced into the device via the channel 22 will be located as closely as possible to the centre of the spherical head 18.

At the end 26 of the stem remote from the head 18 a tapered screw thread is formed, onto which a complementally threaded knurled locking collar or knob 28 can be screwed. The knob has a central aperture 30 which is sized to receive a guide tube 32 of an High Dose Rate, Remotely Controlled After-loading Brachytherapy Unit (HDRRCABU) and to clamp the end of the tube in position once it is correctly attached to the device, by hand tightening the knob onto the thread 26.

The body of the device is preferably manufactured from a single piece of PTFE or “Teflon” (trade mark) or another suitable material which has the required properties of being substantially transparent to ionising radiation and being tissue compatible as far as possible. Obviously, the material of the device should be non reactive and not be toxic or irritating to human tissue. Apart from PTFE, other medical grade plastics materials should be suitable for the manufacture of the device.

The prototype device had a head 18 which was 50 millimeters in diameter, with a stem or handle 20 which was 100 millimeters long and 15 millimeters in diameter. The channel 22 had a diameter of 3 millimeters and the end 24 thereof extended past the geometric centre of the spherical head 18 by approximately 2.5 millimeters.

The head 18 of the device can have a diameter from approximately 40 to 70 millimeters, to cater for different sized wound cavities. It will be appreciated that this range of sizes is purely exemplary, and the size and also the shape of the head can be adjusted according to the size and nature of the wound cavity and the tumour bed to be treated. For example, the head of the device could be ellipsoidal or banana-shaped instead of being spherical or spheroidal.

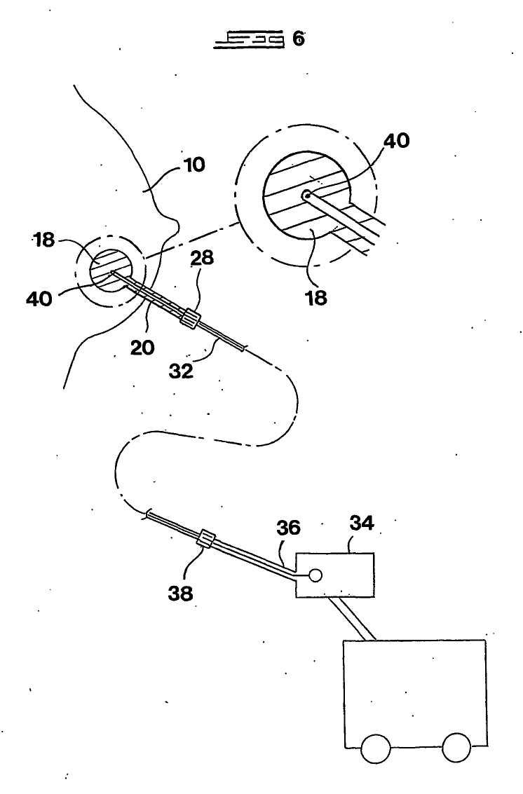

Referring to FIGS. 3, 4 and 6, the radiation application device is shown in use. FIG. 3 shows schematically the radiation application device of the present invention being applied to the wound cavity 14. The stem 20 of the device extends from the wound edges 16, which are preferably stitched closed around the stem so that the head of the device is effectively buried within the wound cavity as an obturator or plug. A device having a suitable head diameter is chosen so that the breast tissue must be stretched somewhat to ensure firm contact of the wound cavity walls with the rigid outer surface of the head. This has the important result that the position, depth and size of the wound cavity and the tissue to be irradiated are known with certainty.

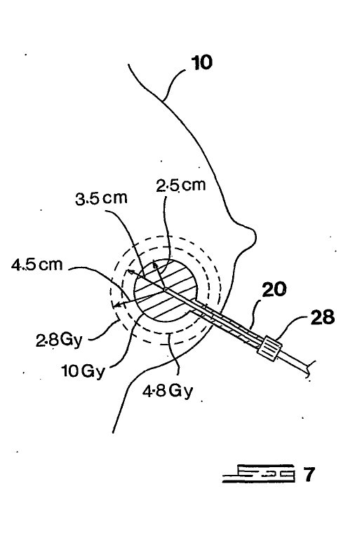

As seen in FIG. 6, a conventional HDRRCABU 34 is used in conjunction with the applicator device of the invention. A main guide tube 36 extends from the head of the HDRRCABU 34 and is provided with a coupling 38 which permits the guide tube 32 to be attached thereto. The guide tube 32 will typically be a 200 millimeter non-flexible stainless steel tube of approximately 2 millimeter diameter. Instead of a rigid tube, a flexible tube might be preferred in certain cases.

Within the head of the HDRRCABU 34 is a drum on which is wound a length of piano wire or similar stiff wire, with a small radioactive source 40 fixed to the end thereof. The source is preferably cylindrical or spherical and comprises Iridium 192 or another source suitable for irradiation of human tissue. The source is sufficiently small to act as an isotropic point source. The source dimensions of a typical commercially available HDRRCABU are about 0.5 millimeters in diameter and about 5 millimeters in length. The location of the end 24 of the channel 22 in the head of the prototype device was determined by these dimensions. This would not preclude the use of a special spherical isotope source other than ¹⁹²Ir, for example ³⁷Cs.

With the guide tube 32 clamped firmly in place between the stem 20 of the applicator device and the main guide tube 36 of the HDRRCABU 34, the machine can be operated to drive the wire and thus the radioactive source 40 along the tubes, into the centre of the head 18 of the applicator device.

FIG. 7 shows an example of the isotropic radiation intensity/dose distribution due to the radioactive source 40 at the centre of the head 18 of the radiation application device. Assuming that the diameter of the head 18 is 50 millimeters, that is, the radius is 2.5 centimeters, and assuming a dose at the surface of the applicator of 10 Gy, the dose 1 centimeter away from the applicator will be 4.8 Gy, and the dose 2 centimeters away will be 2.8 Gy.

In a practical application, the following radiobiological considerations will be taken into account.

The so called alpha/beta ratio is a very well tested quantity in the linear quadratic model of radiation damage. This model was first introduced by Lea and Catcheside already in 1942, and shown to be applicable to clinically relevant radiation damage by Dale and co-workers in the United Kingdom and by Orton and co-workers in the United States of America. The damage caused by a particular schedule of irradiation to the cancerous tissue as well as to the normal tissues can be predicted with a very fair degree of confidence by aid of the linear quadratic model.

The alpha/beta ratio for cancerous tissue is usually about 7 Gy and for the relevant normal tissues of the breast (excluding the skin) it is 2 Gy.

For a dose of 50 Gy delivered in 5 weeks in 2 Gy increments, the Biologically Effective Damage to cancerous tissue and skin is given by

$$\begin{matrix}B E D ( 7 ) = n D ( 1 + \underline{d} ) G y \\ = 25 \times 2 ( 1 + 2 / 7 ) G y \\ = 64.28 G y\end{matrix}$$

For the relatively large volume encompassed by the additional “booster” dose, the value for the BED(7) will be 77.14 Gy. It is therefore necessary to calculate equivalent values for the radiation application device of the present invention.

If a single dose of 21 Gy delivered to the surface of the applicator is chosen, then a “shell” of tissue 1 cm thick will receive the following doses:

A: Tissue in contact with the surface of the applicator:

BED(7)=21(1+21/7)Gy=84 Gy

So it can be shown that at 1 mm from the surface, the BED(7) will be 73 Gy, about the same as a radical dose plus booster dose, and at 2 mm from the surface, the BED(7) will be 64 Gy, or equivalent to the BED(7) of the dose due to full breast irradiation.

At 3 mm from the surface, the BED(7) will be 57.12 Gy and at 5 mm from the surface, 44.89 and at 10 mm from the surface, the BED (7) will be 27.4 Gy (see table 2 below.)

TABLE 1
Volumes Irradiated: Conventional versus the New Method:

| Biologically effective dose to: | Volume irradiated: |
|---|---|
| 1. The whole breast: = 64.4 Gy | approximately |
| | 850 cc |
| 2. Whole breast plus tumor bed: 77.16 Gy | 600 cc |
| Shell of breast tissue from the surface of the | 114 cc |
| applicator of diameter 5 cm: The dose drops | |
| from 21 Gy surface dose to 26.9 Gy at a radius | |
| of 3.5 cm and the volume of this irradiated | |
| shell of tissue is | |

Therefore volume of breast tissue spared from irradiation: (80−114)cc=686 cc.

The volumes given above are exemplary and relate to an “average” sized breast. The volume in each case may vary, of course, according to the size of the breast.

TABLE 2
Variation of the radiation dose from the surface
of a 5 cm diameter spherical applicator:
Table 1 shows how the dose drops from 21 Gy at the
surface of the applicator to the radii indicated, as well
as the volumes of tissue irradiated to the
corresponding dose levels.

| Radius(cm) | Dose(Gy) | BED(7)(Gy) | Volume irradiated (cc) |
|---|---|---|---|
| 2.5 | 21 | 84 | 0 |
| 2.7 | 18 | 64 | (82.5-65.5) = 1 |
| 2.8 | 16.8 | 57 | (92.0-65.5) = 26.5 |
| 3.0 | 14.5 | 47.5 | (113-65.5) = 47.5 |
| 3.5 | 10.8 | 27.4 | (179.7-65.5) = 114.2 |

Generally, the method of the invention can be used to deliver a radiation dose at the surface of the applicator in the range 5 to 30 Gy.

The selection of patients for lumpectomy has been greatly refined in the last two decades. Lumpectomies are not undertaken in patients with very small breasts, or very large breasts (this may change, as the very large breasts are difficult to manage technically with conventional irradiation, and the radiotherapy complications tend to be more severe). Lumpectomies are also not undertaken in patients with multifocal disease or histologies associated with multifocal disease, like ductal carcinoma in situ or lobular carcinoma.

The lumpectomy is designed to remove a margin of macroscopically normal (non infiltrated) tissue around the tumor of about 2 cm in thickness. Irradiating an additional volume of about 50 cc that will still have a significant tumoricidal effect, will add significantly to lowering the chance of a local recurrence. Since the dose is reduced very fast with distance due to the isotropic nature of the source, the risk of radiation damage to the lungs, ribs, skin and heart (in the left breast) is virtually eliminated.

TABLE 3
The volumes of surgically removed breast tissue plus
the value sterilized in principle by the irradiation:

| | | Volume of | Volume of surgically |
|---|---|---|---|
| Tumor | Volume of | surgically | removed plus |
| diameter | tumor(cc)* | removed shell | irradiated shell |
| 1 | 0.5 | 65.5 | 182.5 |
| 1.5 | 1.8 | 87.2 | 201.2 |
| 2.0 | 4.2 | 113.1 | 227.1 |
| 2.5 | 8.2 | 143.8 | 257.8 |

*Assuming a spherical lesion, volume = 4/3 × 22/7 × radius × radius × radius., and that 114 cc of breast tissue is irradiated in the dose range 2 Gy to 10.7 Gy, i.e. a rim or layer of tissue around the applicator of 10 mm thickness. Generally, the method of the invention would be suitable to treat a layer of tissue surrounding the applicator body of between 0 and 20 millimeters thickness.

It is clear that irradiation using the method and apparatus of the invention can as much as treble the volume of tissue rendered “safe” surgically, yet the irradiated volume is only about 25% of the volume of breast tissue irradiated by the standard current method.

In conventional treatment, which typically comprises a lumpectomy, auxiliary dissection and 50 Gy postoperative radiotherapy plus 10 Gy of additional irradiation to the tumour bed, the total treatment time is relatively long. If one assumes two weeks for surgery and wound healing plus six weeks of radiotherapy, the total treatment time is eight weeks.

Using the present invention, the treatment time comprises the time required for the lumpectomy itself, say one to two hours, plus the time required to insert the applicator and deliver the radiation dose of 21 Gy. This should take approximately half an hour. As soon as the radiation dose has been administered, the applicator can be removed and the wound closed.

The patient can then be discharged. Thus, a great deal of time and expense can be saved. If the tumour should recur, a re-excision of the lesion as well as re-irradiation by conventional means are still possible, which is of further benefit to the patient.

A number of possible variations of the present invention are possible. For example, instead of being designed for use with an HDRRCABU, the device of the invention can be designed for use with a separate radiation source which is inserted into the channel 22 and held in position with a suitable plug extending into the channel. The device can then be inserted into a wound cavity as described above, and left in position for a prescribed period. In such a case, due to the handling of the device that would be required with the radiation source in place, lower dose rate therapy would probably be applied in this way, requiring hospitalisation of the patient for a few days.

Although the delivery of the required radiation dose as a single dose has been described and is generally preferable, the dose could be delivered in several fractions or dose increments if desired. Since the applicator is rigid, regular in shape and non-deformable, the basic dosimetry is much easier and more reliable than it would be with a deformable applicator. This makes a rigid (solid) applicator inherently more predictable and safe as compared to a non-rigid applicator.

1. A radiation application device comprising a body having a head portion shaped to be positioned within a wound cavity resulting from removal of a tumor, and a relatively narrow stem portion sized to protrude out of the wound cavity, the body defining a channel therein for receiving and locating a radiation source in a predetermined position so that tissue of the wound cavity adjacent the head of the device receives a predetermined dose of radiation from the radiation source.

2. A radiation application device according to claim 1 wherein the head portion defines a rigid outer surface which can be brought into firm engagement with the tissue of the wound cavity, thereby to locate the radiation source accurately relative to the tissue.

3. A radiation application device according to claim 2 wherein the body is solid and comprises a material which is substantially transparent to ionizing radiation.

4. A radiation application device according to claim 3 wherein the body comprises PTFE or another suitable plastics material.

5. A radiation application device according to claim 1 wherein the head portion is spherical or spheroidal.

6. A radiation application device according to claim 5 wherein the head portion has a diameter in the range 40 to 70 millimeters.

7. A radiation application device according to claim 1 wherein the channel in the body is tubular and is sized to receive a guide tube for the radiation source.

8. A radiation application device according to claim 7 wherein the channel extends through and terminates a distance beyond the center of the head portion calculated to position the radiation source at the center of the head portion in use.

9. A radiation application device according to claim 7 wherein the stem portion has a coupling provided at an end thereof remote from the head portion which is adapted to receive the guide tube and to clamp it in position relative to the device.

10. A radiation application device according to claim 9 wherein the coupling is compatible with a guide tube of a conventional High Dose Rate, Remotely Controlled After-loading Brachytherapy Unit (HDRRCABU).

11. A method of administering radiation to human tissue comprising:
locating a radiation source in an applicator body defining a rigid wound-engaging surface;
inserting the applicator body into a wound cavity so that the wound-engaging surface thereof is in contact with the tissue defining the cavity;
leaving the applicator body in position in the cavity for a period of time calculated to deliver a desired dose of radiation to the tissue adjacent the cavity; and
removing the applicator body from the wound cavity.

12. A method according to claim 11 wherein the applicator body is inserted via a wound opening which is closed about the body so that the tissue defining the wound cavity contacts the tissue-engaging surface of the body firmly.

13. A method according to claim 11 or wherein the radiation source is introduced into the applicator body via a guide tube after insertion of the applicator body into the wound cavity.

14. A method according to claim 11 wherein the radiation source is an isotropic point source.

15. A method according to claim 11 wherein the radiation source comprises Iridium 192 or Caesium 37.

16. A method according to claim 11 wherein the radiation dose delivered at the surface of the applicator is in the range 5 to 30 Gy.

17. A method according to claim 16 wherein the radiation dose delivered at the surface of the applicator is about 21 Gy.

18. A method according to claim 17 wherein the radiation dose is effectively administered to a layer of tissue surrounding the applicator body with a thickness between 0 and 20 millimeters.

19. A method according to claim 18 wherein the radiation dose is effectively administered to a layer of tissue surrounding the applicator body with a thickness of about 10 millimeters.

20. A method according to claim 11 wherein the radiation dose is delivered as a single dose.
